(19) United States
(12) Patent Application Publication
(10) Pub. No.: US 2008/0043964 A1
(43) Pub. Date: Feb. 21, 2008

(54) Audio conferencing bridge

(76) Inventors: Kenneth D. Majors, Lake Oswego, OR (US); Scott Deboy, Hillsboro, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 11/879,096

(22) Filed: Jul. 16, 2007

Related U.S. Application Data
(60) Provisional application No. 60/830,918, filed on Jul. 14, 2006.

(51) Int. Cl. H04M 3/42

(52) U.S. Cl. 379/202.01

(57) ABSTRACT

A conferencing system that synchronizes an audio file from audio conferencing bridge with a video file from the conferencing system.

### CROSS-REFERENCE TO RELATED APPLICATIONS

This application claims the benefit of 60/830,918 filed Jul. 14, 2006.

### BACKGROUND OF THE INVENTION

The present invention relates to an audio conferencing bridge.

Audio conferencing is used to facilitate meetings, document reviews, and make presentations. During an audio conference, parties attempt to use the conference time efficiently. To increase the efficiently, copies of reports, documents, and presentations may be distributed ahead of time. While it is a preferable to share information before a scheduled conference call, sometimes the participants are not able to review the materials ahead of time. Frequently there exists situations where it is difficult or time consuming to transfer the materials to all that are attending the meeting, or otherwise there are times during which not everyone is available.

The audio conferencing may be performed by systems that are based on the traditional Public Switch Telephone Network (PSTN) or Internet based audio conferencing products that support multi-point Internet based audio conferencing. Such Internet based audio conferencing products typically rely on desktop software and/or server based software to facilitate the audio conferencing.

### BRIEF DESCRIPTION OF THE SEVERAL VIEWS OF THE DRAWINGS

FIG. 1 illustrates an audio conferencing bridge.

FIG. 2 illustrates a video conferencing system.

FIG. 3 illustrates the audio and video from FIG. 1 and FIG. 2.

### DETAILED DESCRIPTION OF PREFERRED EMBODIMENT

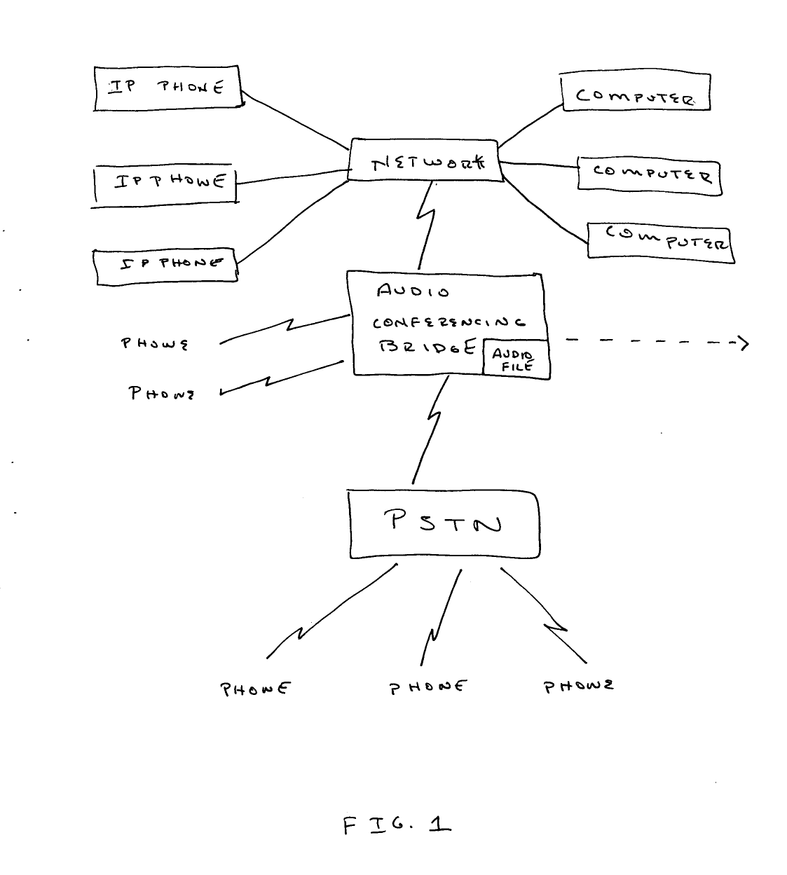

Referring to FIG. 1, a system may include an audio conferencing bridge for a group of conference attendees. The conferencing bridge may include a plurality of dial-in-ports which can be programmed to accept calls from potential attendees. The conference bridge can process audio communications which are received through the Public Switch Telephone Network (PSTN) or via Internet based telephony. The audio conferencing bridge is typically separate from any video conferencing system. The conference attendees may be remotely located and establish connections to the data network through any suitable mechanism.

The connection to the audio conference bridge may be established in a number of ways. In a first way, the conference attendee uses a telephone to establish a connection to the audio conferencing bridge over the PSTN (or IP telephony). Prior to the conference each attendee is provided with a bridge number (typically a conference number), as well as an identification or security number, in order to access to the audio conference. Once the connection to the bridge is established, the conference attendee is requested to enter the identification or security code. During this connection procedure, the user may also be asked to provide a variety of different forms of information in order to facilitate the establishment of the conference.

An audio connection through the bridge may also be established using IP telephony. In this type of connection, the workstation or IP telephone of the conference attendee includes hardware and software for establishing an audio connection over the data network. The hardware may include a computer with a microphone and speakers, or a traditional style IP phone. The software converts the analog audio to a digitized form and transmits it over the data network. This IP telephony connection may be established directly through a network to the conference bridge, or any other suitable manner.

The audio conference which is established over the conference bridge may have a meeting leader. The meeting leader will in most cases have the same type of interface device that the other attendees do. In some cases, the audio conferencing bridge may provide a monitor that has direct access to the conferencing bridge.

During the audio conference, the conferencing bridge facilitates all of the attendees to discuss matters among themselves. Also, the conferencing bridge may likewise create an audio file with the contents of all or part of the conference. The audio file is preferably saved in some manner so that it can be retrieved later and reflects some or all of the discussions during the audio conferencing bridge. In this manner, the attendees may download and/or listen to the audio file in order to review the discussion at a later time. Moreover, at times one or more individuals will be unable to attend the audio conference at the specified time. In this event the missing individuals may download and/or listen to the audio file at a later time to be informed of the discussion that took place.

Many business activities are performed by teams of individuals that may be widely dispersed geographically. For example, product design and manufacturing are commonly performed by teams having members who are often located in facilities spread around the globe and/or who may be in transit between locations. If a decision is to be made concerning the project it may be necessary to quickly gather input and consensus from the members of the team regardless of their physical remoteness. Modern communication technology enables individuals to communicate over long distances and from remote locations. Conferencing systems facilitate communication between a plurality of remotely located users or conferees by allowing multiple users to communicatively interconnect with each other either directly as peers or by interconnecting with a central server that is interconnected to the other participants in the conference. Computer-based conferencing systems commonly provide for audio and video input from each of the conferees. Also, text based sharing and desktop sharing may also be facilitated through the conferencing system. In addition, a conferencing system may provide file sharing enabling conferees to view and edit files, including engineering drawings and spreadsheets, that are part of the team's project. Also, the conferencing system may record the desktop as a video sequence on one or more desktops.

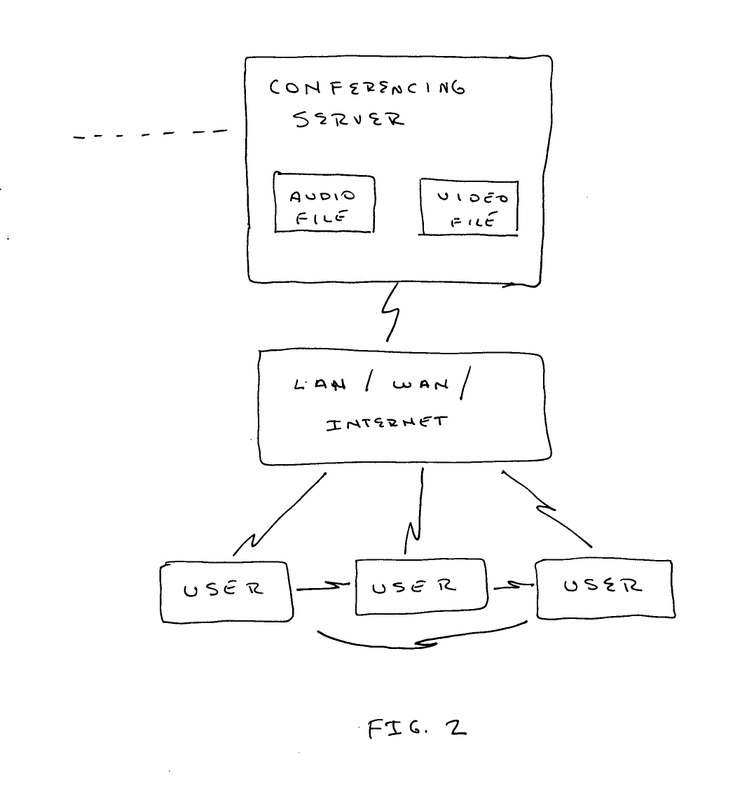

Referring to FIG. 2, a remote conferencing system comprises a plurality of remotely located, user operated, conferencing interface devices that are communicatively interconnected. A conferencing interface device is a source and/or a sink of the audio, video and/or textual data comprising a conference and represents a conference location where one or more conference participants or conferees can participate in a conference. The conferencing interface devices may be interconnected as a plurality of peers that simultaneously function as both a “client” and a “server” to the other nodes of a network of conferencing interface devices. However, the conferencing interface devices are commonly communicatively interconnected through a conferencing server with the interface devices acting as clients sending requests to the server and receiving information from the server. The system may also include a peer-to-peer communication technique. Also, the system may include peer-to-peer and client-server relationships. Some arrangements may be more effective with limited bandwidth. The communication links between users may comprise portions of a local area network (LAN) within a facility and/or a wide area network (WAN) that commonly includes the Internet, a global network of communicatively interconnected computing systems. The audio and/or video may be transmitted within the network using a multicast technique, a Unicast technique, or a UDP technique, for example.

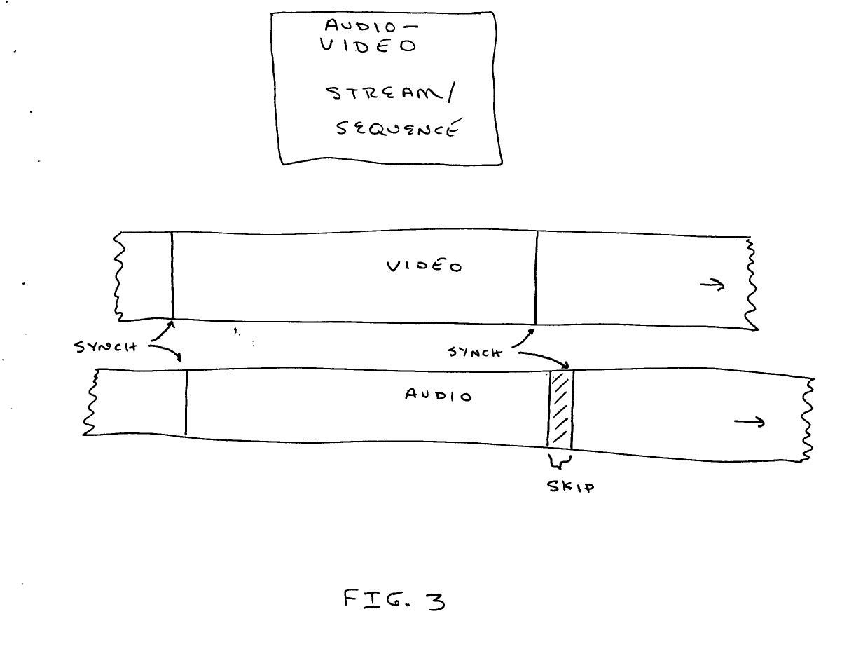

Referring to FIG. 3, it has been determined that the existing audio conferencing bridges tend to be robust, easy to use, and reliable. The audio conferencing bridge is typically provided by a dedicated provider or otherwise provided by a telephone company. The audio conferencing bridge is typically on a different computer system and remote from the video conferencing system. The audio file resulting from a conference using an audio conferencing bridge is available using a computer network, such as the Internet. Also, the audio file may typically be obtained using the phone system or other suitable interface. During such use of the audio conferencing bridge, it may likewise be desirable to use a conferencing system for sharing video, desktop sharing, or other use that is recorded as a video stream for later reviewing.

The conferencing system includes an interface which permits a user to show the video stream in some graphical manner. One such manner is a time bar on the lower portion representing the length of the video together with the corresponding video being presented in another window. The audio file obtained from the audio conferencing system is likewise preferably presented to the user in some graphical format. The audio file may include a bar that shows the current played portion of the audio file. It also permits the user to adjust the location that is to be played. Both the video and audio may include control functions, such as play, fast forward, rewind, fast rewind, pause. The user may designate a location in the audio file to correspond with a location in the video file. In this manner, the conferencing system may subsequently play the audio file together with the video file to provide a more complete audio visual experience. The time scale of the audio file and the video file are preferably matched during playing. Also, the audio file and/or the video file and/or an information file is modified in such a manner so that the files may be played together at a later time in a synchronized manner. Moreover, the video and audio may be combined into a audio video format, such as MPEG. In some cases, it is possible that the audio file may not perfectly track the video file, and in such cases adjustments may be made to skip ahead or back in the audio file and/or video file to resynchronize the files together.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

1. A conferencing system comprising:
(a) said conferencing system including video conferencing to facilitate multiple users simultaneously sharing a video stream, and storing said video stream in a video file;
(b) an audio conferencing bridge to facilitate said multiple users simultaneously sharing audio communication and storing said audio communication in an audio file, where said audio conferencing bridge is separate from said conferencing system;
(c) synchronizing said audio file and said video file with one another;
(d) playing said audio file and video file together to a user of said conferencing system.

2. The conferencing system of claim 1 wherein said audio conferencing bridge includes PSTN.

3. The conferencing system of claim 1 wherein said audio conferencing bridge includes IP telephony.

4. The conferencing system of claim 1 wherein said audio file is stored by the entity providing said audio conferencing bridge.

5. The conferencing system of claim 1 wherein said conferencing system includes an interface to facilitate said synchronization of said audio file and said video file with one another.

6. The conferencing system of claim 5 wherein said interface of said conferencing system facilitates multiple parts of said audio file and said video file to be synchronized with one another.
